(19) United States
(12) Patent Application Publication
(10) Pub. No.: US 2024/0329980 A1
(43) Pub. Date: Oct. 3, 2024

(54) MULTI-PATTERN BUILD EVALUATION METHOD AND COMPUTER PROGRAM PRODUCT

(71) Applicant: Panasonic Automotive Systems Co., Ltd., Kanagawa (JP)

(72) Inventors: Kentaro MURAI, Kanagawa Ken (JP); Hideaki YAJIMA, Kanagawa Ken (JP); Takeshi MASHIKO, Kanagawa Ken (JP); Seigo TAKADA, Osaka Fu (JP)

(73) Assignee: Panasonic Automotive Systems Co., Ltd., Kanagawa (JP)

(21) Appl. No.: 18/606,059

(22) Filed: Mar. 15, 2024

(30) Foreign Application Priority Data
Mar. 29, 2023 (JP) 2023-052818

(51) Int. Cl. G06F 8/71

(52) U.S. Cl. CPC G06F 8/71

(57) ABSTRACT

A multi-pattern build evaluation method according to the present disclosure includes acquiring, for each of a plurality of changed source codes, change information including information indicating a changed source code and synchronous element information indicating a synchronous element related between the changed source code and another changed source code, generating two or more packages including one or more pieces of the change information based on the synchronous element information between the plurality of changed source codes, and generating an overall build pattern including all of the two or more packages and partial build patterns including some of the two or more packages.

### CROSS-REFERENCE TO RELATED APPLICATIONS

This application is based upon and claims the benefit of priority from Japanese Patent Application No. 2023-052818, filed on Mar. 29, 2023, the entire contents of which are incorporated herein by reference.

### FIELD

Embodiments described herein relate generally to a multi-pattern build evaluation method and a computer program product.

### BACKGROUND

In a conventional source code combining process in large-scale development, source codes changed and tested individually in each category are combined with a main source tree. At this time, it is known that a conflict in the contents of changes between categories causes a build error, when test results of the categories are combined, although the test results are normal.

Meanwhile, for example, there are technologies, for any combination, to individually identify a changed version leading to a defect and the contents thereof, from change information about the source code. Conventional technologies are described in JP 2019-114043 A and JP 2015-011372 A, for example.

However, there is a problem that it is impossible to detect in advance which combination causes the build error, taking time to analyze the build error upon occurrence of the build error. There is a further problem that use of a brute-force test for all combinations of changes to identify a combination of changes that causes the build error takes a large amount of time, thus leading to incompletion of the build within a desired deadline.

### SUMMARY

A multi-pattern build evaluation method according to an embodiment of the present disclosure includes acquiring, for each of a plurality of changed source codes, change information including information indicating a changed source code and synchronous element information indicating a synchronous element related between the changed source code and another changed source code; generating two or more packages including one or more pieces of the change information based on the synchronous element information between the plurality of changed source codes; and generating an overall build pattern including all of the two or more packages and partial build patterns including some of the two or more packages.

### BRIEF DESCRIPTION OF THE DRAWINGS

FIG. 1 is a diagram illustrating an exemplary configuration of a multi-pattern build evaluation system according to an embodiment;

FIG. 2 is a diagram illustrating an exemplary hardware configuration of devices of the multi-pattern build evaluation system according to the embodiment;

FIG. 3 is a diagram illustrating an exemplary functional configuration of a source code management server according to the embodiment;

FIG. 4 is a diagram illustrating an exemplary functional configuration of a build job management server according to the embodiment;

FIG. 5 is a flowchart illustrating an example of an evaluation process performed by the multi-pattern build evaluation system according to the embodiment;

FIG. 6 is a table illustrating an example of a development ticket in a multi-pattern build evaluation method according to the embodiment;

FIG. 7 is a table illustrating an example of change information in the multi-pattern build evaluation method according to the embodiment;

FIG. 8 is a table illustrating an example of change information in the multi-pattern build evaluation method according to the embodiment;

FIG. 9 is a diagram illustrating packing in the multi-pattern build evaluation method according to the embodiment;

FIG. 10 is a diagram illustrating generation of an overall build pattern in the multi-pattern build evaluation method according to the embodiment;

FIG. 11 is a diagram illustrating generation of a partial build pattern in the multi-pattern build evaluation method according to the embodiment;

FIG. 12 is a diagram illustrating generation of a partial build pattern in the multi-pattern build evaluation method according to the embodiment; and

FIG. 13 is a diagram illustrating generation of a partial build pattern in the multi-pattern build evaluation method according to the embodiment.

### DETAILED DESCRIPTION

Embodiments of a multi-pattern build evaluation system, a multi-pattern build evaluation method, a computer program product, and a recording medium according to the present disclosure will be described below with reference to the drawings.

In the description of the present disclosure, component elements having the same or substantially the same functions as those having been described with reference to previous drawings are denoted by the same reference numerals, and the description thereof is appropriately omitted, in some cases. In addition, even when the same or substantially the same portions are illustrated, the dimensions and ratios may be represented differently from each other depending on drawings. Furthermore, for example, from the viewpoint of ensuring visibility of the drawings, only main component elements are denoted by reference numerals in description of the drawings, and even if component elements having the same or substantially the same functions as those having illustrated in previous drawings are illustrated, the component elements may not be denoted by reference numerals.

Note that in the description of the present disclosure, component elements having the same or substantially the same functions may be distinguished from each other by reference numerals followed by alphanumeric characters. Alternatively, when a plurality of component elements having the same or substantially the same functions are not distinguished, the component elements may be collectively described by the reference numerals without the alphanumeric characters.

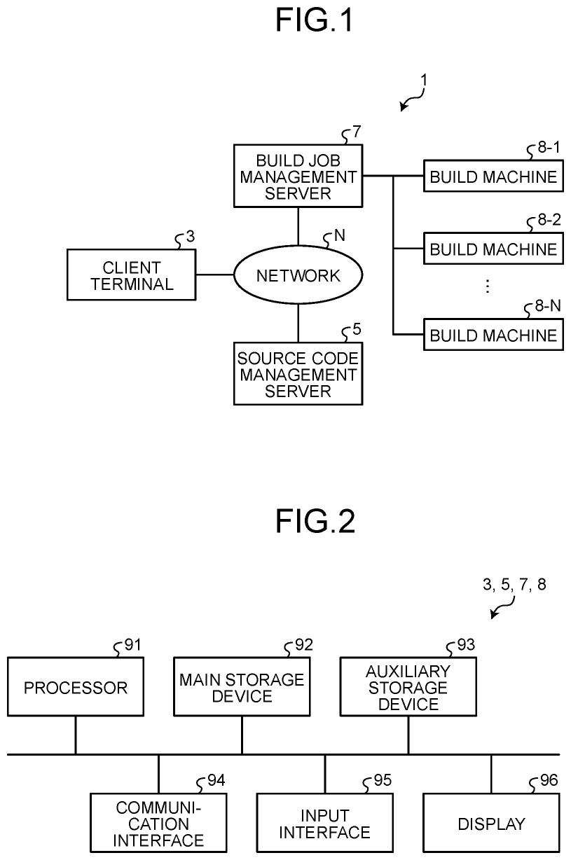

FIG. 1 is a diagram illustrating an exemplary configuration of a multi-pattern build evaluation system 1 according to an embodiment. As illustrated in FIG. 1, the multi-pattern build evaluation system 1 includes a client terminal 3, a source code management server 5, a build job management server 7, and a plurality of build machines 8. The client terminal 3, the source code management server 5, and the build job management server 7 are communicably connected via a network N that is a telecommunication line such as the Internet. Furthermore, the build job management server 7 is communicably connected to each of the plurality of build machines 8.

The client terminal 3 receives an operation input by a user. In an example, the client terminal 3 acquires a target due date and submission priority that are to be filled in a development ticket, on the basis of the operation input by the user, and outputs the target due date and the submission priority to the source code management server 5. In an example, the client terminal 3 acquires change information on the basis of the operation input by the user, and outputs the change information to the source code management server 5.

The source code management server 5 manages the development ticket, change information, and link information, relating to a source code. In an example, the source code management server 5 acquires an input of the target due date and the submission priority from the client terminal 3 so that the target due date and the submission priority are filled in the development ticket. In an example, the source code management server 5 manages the source code of each version. In an example, the source code management server 5 manages the development ticket, a modified source code based on the development ticket, and a synchronous element related to the modified source code, in association with each other, as the change information. In an example, the source code management server 5 manages the link information defining the synchronous element.

Note that the development ticket about the source code may be separately managed by a development ticket management server. The development ticket management server may be provided in the multi-pattern build evaluation system 1 according to the embodiment, or may be provided as an external server. For example, as illustrated in FIG. 2, the development ticket management server has a hardware configuration similar to that of the source code management server 5 or the build job management server 7. In an example, the development ticket management server may acquire an input of the target due date and the submission priority from the client terminal 3 so that the target due date and the submission priority are filled in the development ticket. Furthermore, the source code management server 5 may refer to the development ticket managed by the development ticket management server.

The build job management server 7 collectively manages the plurality of build machines 8. In an example, the build job management server 7 collects links to the synchronous elements relating to changes of a plurality of source codes, thereby collectively packing the synchronous elements. In an example, the build job management server 7 generates a build pattern by grouping the change information, on the basis of synchronous element information indicating association between the source codes included in the respective change information. In an example, the build job management server 7 allocates an overall build pattern and partial build patterns to the plurality of build machines 8 and causes each of the build machines 8 to execute a build.

The plurality of build machines 8 executes the builds for the build patterns allocated by the build job management server 7. Note that FIG. 1 illustrates N build machines 8-1, 8-2, . . . , and 8-N(N is a natural number).

FIG. 2 is a diagram illustrating an exemplary hardware configuration of devices of the multi-pattern build evaluation system 1 according to the embodiment.

Each of the client terminal 3, the source code management server 5, the build job management server 7, and the build machines 8 includes a processor 91, a main storage device 92, an auxiliary storage device 93, a communication interface 94, an input interface 95, and a display 96. The processor 91, the main storage device 92, the auxiliary storage device 93, the communication interface 94, the input interface 95, and the display 96 are communicably connected by, for example, an internal bus.

Note that the source code management server 5, the build job management server 7, and each build machine 8 may not include the input interface 95 and the display 96.

The processor 91 controls the overall operations in each device. As the processor 91, various processors such as a central processing module (CPU), a graphics processing module (GPU), an application specific integrated circuit (ASIC), and a field programmable gate array (FPGA) can be used as appropriate.

The main storage device 92 temporarily stores active data in each device. As the main storage device 92, for example, a random access memory (RAM) can be used.

The auxiliary storage device 93 stores various data and programs used in each device. As the auxiliary storage device 93, various storage media and storage devices such as a read only memory (ROM), a hard disk drive (HDD), a solid state drive (SSD), and a flash memory can be used as appropriate.

In an example, the auxiliary storage device 93 of the source code management server 5 stores information indicating the source code, change information, and the link information. The information indicating the source code is information that indicates the source code before changing, to which the source code after changing that is build OK is to be combined, and is at least one of the source code and information indicating an access destination of the information indicating the source code. The change information includes information indicating the development ticket giving an instruction on the change of the source code, information indicating the changed source code, and the synchronous element information indicating the synchronous element related between the changed source code and another changed source code. The information indicating the changed source code is at least one of the source code after changing, information indicating a content of the change of the source code, and information indicating an access destination of either the source code or information indicating the content of the change. The synchronous element is a change number or defined link information indicating a change made by another user on which a change made by the user him-/her-self depends. The link information is information defining the synchronous element. Note that, when the synchronous element is registered by the user, the link information may not be stored.

In an example, the auxiliary storage device 93 of the build job management server 7 stores build machine information and average build speed information, for each of the plurality of build machines 8. The build machine information is information indicating a processing capability related to the build, such as a processing speed and the number of parallel cores of each build machine 8. The average build speed information includes a processing speed and a speed in each step. The auxiliary storage device 93 of the build job management server 7 stores generated packages, build patterns, and build results.

The communication interface 94 is a circuit for communicating with the outside via the network N, in the client terminal 3, the source code management server 5, and the build job management server 7. Furthermore, the communication interface 94 is a circuit for communication between the build job management server 7 and each of the plurality of build machines 8. For the communication interface 94, a communication circuit for wired communication, a communication circuit for wireless communication, and a combination thereof can be used as appropriate. For the communication circuit for wireless communication, a communication circuit supporting various standards such as 3G, 4G, 5G, Wi-Fi (registered trademark), and Bluetooth (registered trademark) can be used as appropriate.

The input interface 95 acquires an operation input by the user in each device. For the input interface 95, an input device such as a keyboard or a touch screen can be used as appropriate.

The display 96 presents a display screen to the user. For the display 96, a liquid crystal display (LCD), an organic electro-luminescence (EL) display, a projector, or the like can be used as appropriate. The display 96 may be configured as a touch screen display. In this configuration, the touch screen of the display 96 is provided, for example, on the surface of the display 96 and outputs information according to a touched position. The touch screen of the display 96 is an example of the input interface 95 that acquires the operation input by the user.

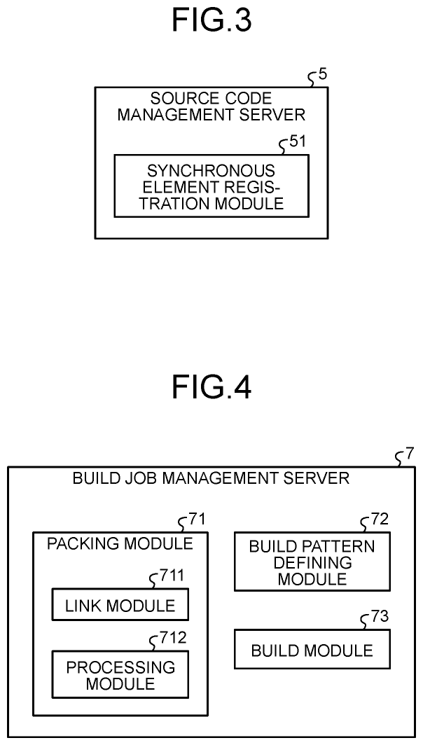

FIG. 3 is a diagram illustrating an exemplary functional configuration of the source code management server 5 according to the embodiment. In the source code management server 5, the processor 91 executes a program read from the auxiliary storage device 93 and loaded into the main storage device 92 to implement a function as a synchronous element registration module 51.

The synchronous element registration module 51 receives registration of the synchronous element on the basis of the user's input in the client terminal 3. Alternatively, the synchronous element registration module 51 receives specification of whether to link the synchronous element in what units, on the basis of the user's input in the client terminal 3.

FIG. 4 is a diagram illustrating an exemplary functional configuration of the build job management server 7 according to the embodiment. In the build job management server 7, the processor 91 executes a program read from the auxiliary storage device 93 and loaded into the main storage device 92 to implement the functions of a packing module 71, a build pattern defining module 72, and a build module 73.

The packing module 71 acquires the change information for each of a plurality of changed source codes. The change information includes information indicating the changed source code, and the synchronous element information indicating the synchronous element related between the changed source code and another changed source code.

Furthermore, the change information includes, for example, synchronous element information defined by the user. Alternatively, the packing module 71 defines the synchronous element on the basis of a reference destination to the changed source code. Alternatively, the change information includes information indicating the development ticket giving an instruction on the change of the source code. In this case, the packing module 71 defines the synchronous element on the basis of the information indicating the development ticket.

In addition, the packing module 71 generates two or more packages including one or more pieces of change information, on the basis of the synchronous element information between the plurality of changed source codes.

The build pattern defining module 72 generates an overall build pattern including all of the two or more packages and partial build patterns including some of the two or more packages.

For example, when the change information includes the information indicating the development ticket giving an instruction on the change of the source code, the build pattern defining module 72 generates the partial build pattern on the basis of a build priority defined by the development ticket. For example, when the change information includes error information upon a past build, the build pattern defining module 72 generates the partial build patterns including two or more of the packages having caused an error in the past build.

The build module 73 causes the build machines 8 to execute builds of a plurality of source codes defined by the overall build pattern and one or more source codes defined by the partial build patterns. When the build of the overall build pattern is successfully executed, the build module 73 adopts a build result of the overall build pattern. When the build of the overall build pattern results in failure, the build module 73 adopts a build result from one or more build patterns for which the builds are successfully executed, of the partial build patterns.

For example, when the change information includes the information indicating the development ticket giving an instruction on the change of the source code, the build module 73 allocates resources of build destinations to the partial build patterns in descending order, sequentially from a partial build pattern including the change information having a higher build priority defined by the development ticket, subsequent to the overall build pattern. For example, when the change information includes the error information upon a past build, the build module 73 preferentially allocates a resource of the build destination to a partial build pattern having caused an error in the past build.

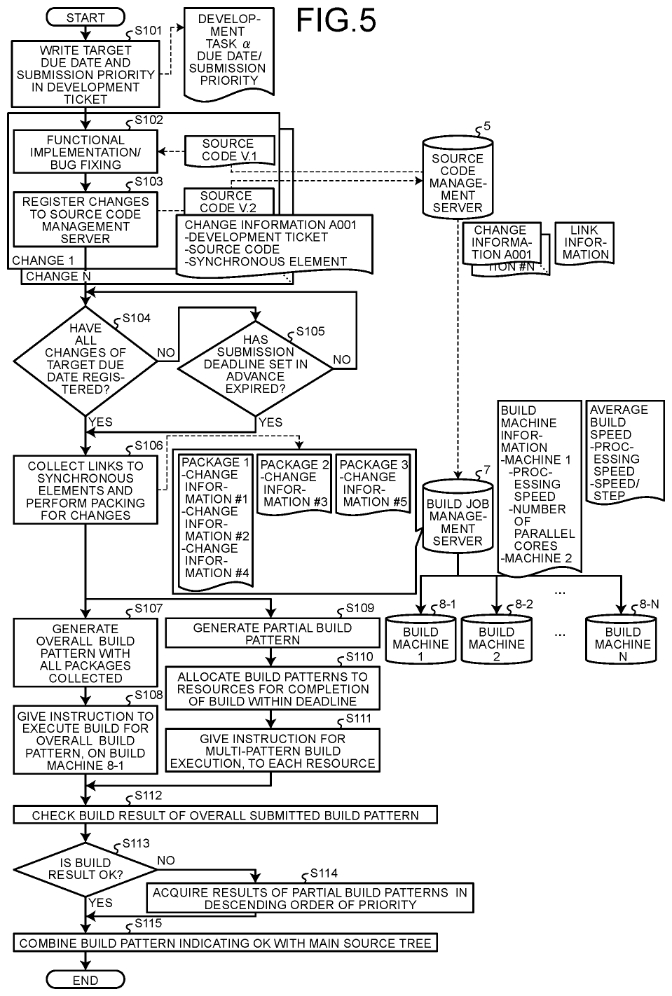

Next, an evaluation process performed by the multi-pattern build evaluation system 1 configured as described above will be described. FIG. 5 is a flowchart illustrating an example of an evaluation process performed by the multi-pattern build evaluation system 1 according to the embodiment.

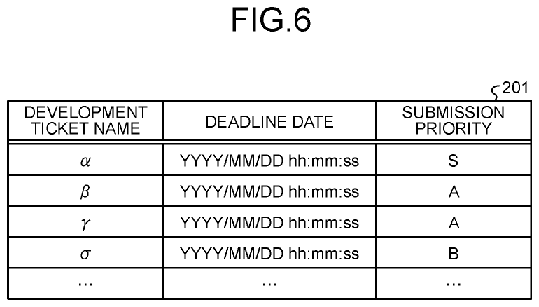

First, a developer (user) writes the target due date and the submission priority of a development task in a development ticket 201 by using the client terminal 3 (S101). FIG. 6 is a table illustrating an example of the development ticket 201 in the multi-pattern build evaluation method according to the embodiment. As illustrated in FIG. 6, the development ticket 201 stores development ticket names, deadline dates, and submission priorities. The submission priorities are each information indicating a priority of execution of the build.

Then, the user uses the client terminal 3 to make a change of a source code such as functional implementation/bug fixing according to a schedule defined in the development ticket 201 (S102). FIG. 5 illustrates changing “source code v.1” stored in the source code management server 5 according to the development ticket (development task α).

In addition, the developer makes a single change or a plurality of changes associated with the development ticket 201 to the source code by using the client terminal 3, and then registers change information 203 indicating each of the changes in the source code management server 5 that manages the source code by using the client terminal 3 (S103).

### (Explicit Specification of Synchronous Element by User)

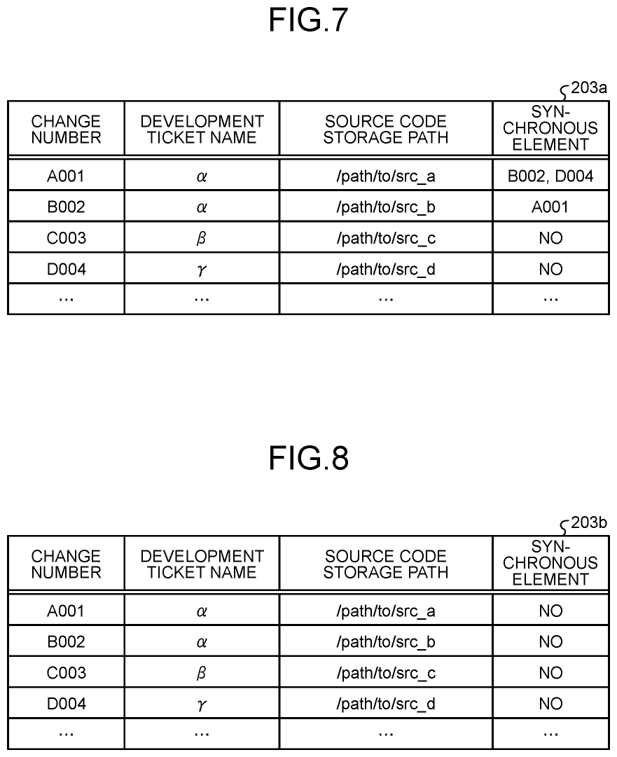

FIG. 7 is a table illustrating an example of change information 203a in the multi-pattern build evaluation method according to the embodiment.

As illustrated in FIG. 7, the change information 203a stores the change numbers, the development ticket names, source code storage paths, and the synchronous elements. The change numbers are each a unique identification number that is assigned to each content of change of the source code and does not overlap a content of another change.

For example, the user specifies, in the change information 203a, a change made by another user on which a change made by the user him-/her-self depends. For example, a user A can grasp that a change A001 made by the user A does not activated unless a change B002 made by a user B and a change D004 made by a user D are taken in, and therefore, when registering the change A001, the change B002 and the change D004 related to the source code of the change A001 made by the user A are registered as the synchronous elements. Meanwhile, except for mutual dependence, the user D who makes the change D004 does not know whether the change A001 made by the user A is necessary for the change made by him-/her-self. In this case, the user D does not specify the change A001 made by the user A.

Note that there may be a case where a content of a change made by another developer is grasped without depending on the source code. In such a case, even if the source code is unknown, the synchronous element is preferably registered. Then, the synchronous element registration module 51 of the source code management server 5 acquires the synchronous element registered by the user.

### (Automatic Acquisition of Synchronous Element by System)

FIG. 8 is a table illustrating an example of change information 203b in the multi-pattern build evaluation method according to the embodiment.

As illustrated in FIG. 8, the change information 203b stores the change numbers, the development ticket names, the source code storage paths, and the synchronous elements.

For example, the user specifies, to the source code management server 5, whether to link the synchronous element in what units by using the client terminal 3. The source code management server 5 holds the link information indicating the specified unit of the synchronous element. Note that specifying the link information by using the client terminal 3 may be described in the change information 203b.

In an example, the user can specify an API/source code level as the unit of the synchronous element. In this case, the source code management server 5 defines the synchronous element on the basis of a service call relationship and common function/file reference information.

In an example, the user can specify a source code level as the unit of the synchronous element. In this case, the source code management server 5 defines the synchronous element on the basis of reference information on a file or data, that is, the link information indicating a function used in an identical use case.

As described above, the synchronous element registration module 51 of the source code management server 5 acquires the synchronous element linked in units specified by the user. Specifically, the synchronous element registration module 51 holds the link information in the units specified, in advance, and automatically links changes for which related modification is performed based on information about a difference from the source code before modification.

When not all the changes of the target due date have been registered (S104: No) and a submission deadline set in advance has not expired (S105: No), the build job management server 7 waits for subsequent processing. On the other hand, when all the changes of the target due date have been registered (S104: Yes) or the submission deadline set in advance has expired (S105: Yes), the build job management server 7 starts processing related to packing and build (S106 to S115).

The packing module 71 of the build job management server 7 packs the change information sequentially in descending order of the submission priority, on the basis of the synchronous element information indicating the synchronous element, generating the packages.

First, a link module 711 puts a link to each piece of change information according to the synchronous element.

Note that, when the API/source code level is specified as the unit of the synchronous element, the link module 711 puts a link on the basis of a dependency relationship used upon build. Specifically, the link module 711 creates a dependence relationship list from API external reference information for the source code and reference information for a constant, refers to the created dependency relationship list to link the change related to the source code associated with the change, acquiring the synchronous element.

Note that, when the source code level is specified as the unit of the synchronous element, the link module 711 performs a reverse lookup for a function using the file or data, that is, refers to the use case from a system test result, putting a link to a related function. Specifically, the link module 711 refers to the development ticket name of the change information 203b to put a link to a change that is issued from the same development ticket. For example, a change associated with a certain use case is associated with a development ticket issued when the system test result is NG, the changes associated with the same development ticket are bundled.

Then, a processing module 712 performs packing of the change information sequentially in descending order of submission priority to generate packages.

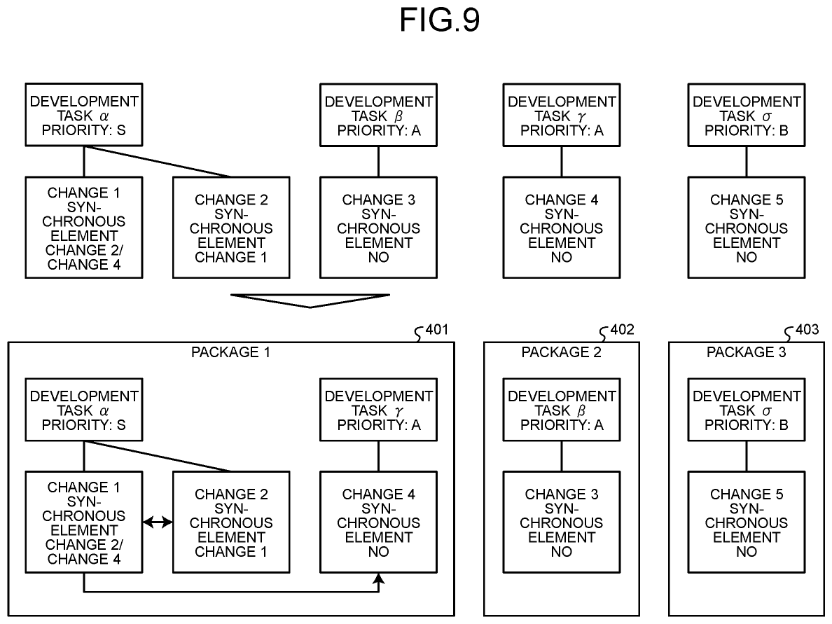

FIG. 9 is a diagram illustrating packing in the multi-pattern build evaluation method according to the embodiment. In FIG. 9, a development task α has a priority S, and is associated with a change 1 and a change 2. The synchronous elements of the change 1 are the change 2 and a change 4. The synchronous element of the change 2 is the change 1. Furthermore, a development task β has a priority A, and is associated with a change 3. The change 3 has no synchronous element. Furthermore, a development task γ has the priority A, and is associated with the change 4. The change 4 has no synchronous element. Furthermore, a development task σ has a priority B, and is associated with a change 5. The change 5 has no synchronous element.

In this configuration, the processing module 712 performs packing sequentially from the change information about the change 1 having the priority S that is higher in submission priority (S106). At this time, the packing is performed for change information to which the link is put based on the synchronous element, together. Therefore, in the example of FIG. 9, the processing module 712 first generates a package 401 including the change information about the change 1, change 2, and change 4. Next, the processing module 712 performs packing on the change information about the change 3 having the priority A to generate a package 402. Then, the processing module 712 performs packing on the change information about the change 5 having the priority B to generate a package 403.

As described above, the packing module 71 according to the embodiment selects change information having a higher priority in build submission, extracts change information on which the selected change information depends, and performs packing on the change information into one package.

Note that the packing module 71 does not follow a link from a use side to a used side. Therefore, for example, in the example of FIG. 9, if the priority of the development task α is A and the priority of the development task γ is S, the package 401 is generated as a package including the change information about the change 4.

Note that, there may be a case in which the package is established when a change on the used side can be submitted without a change on the use side, such as addition of the API or the constant, as in the example described above, but the package is not established without taking the change on the use side, such as the change of the API or the constant. In such a case, a change source synchronization requirement flag may be added as an attribute when the change information about the change 4 is registered. For example, the multi-pattern build evaluation method according to the embodiment may be configured to follow the link in the reverse direction, when the requirement flag is on.

Thereafter, that is, when all pieces of change information about the target due date are registered or the submission deadline set in advance has expired, the build is automatically started (S107 to S111).

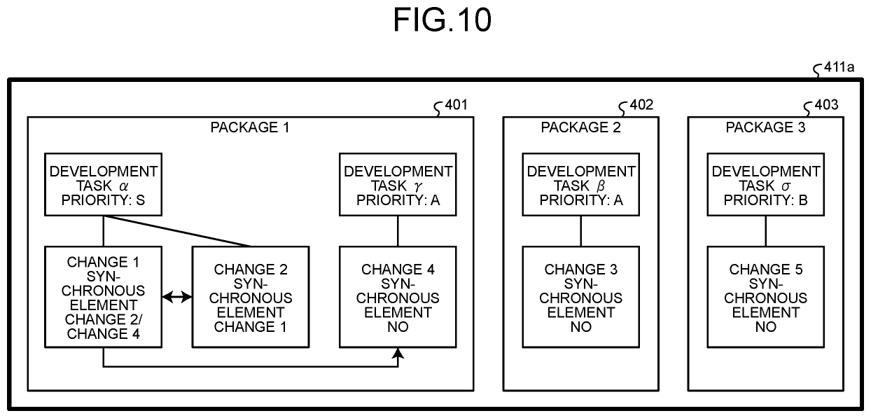

The build pattern defining module 72 generates an overall build pattern 411a including all packages (S107). FIG. 10 is a diagram illustrating generation of the overall build pattern in the multi-pattern build evaluation method according to the embodiment. As illustrated in FIG. 10, the build pattern defining module 72 generates the overall build pattern 411a including all packages 401, 402, and 403 after packing based on the synchronous elements. In addition, the build module 73 allocates the build of the overall build pattern 411a to the build machine 8-1 as the resource, and causes the build machine 8-1 to which the build is allocated to execute the build of the overall build pattern 411a (S108).

Furthermore, the build pattern defining module 72 generates partial build patterns 411b, 411c, and 411d each including some packages, in parallel with the processing of S107 to S108 (S109).

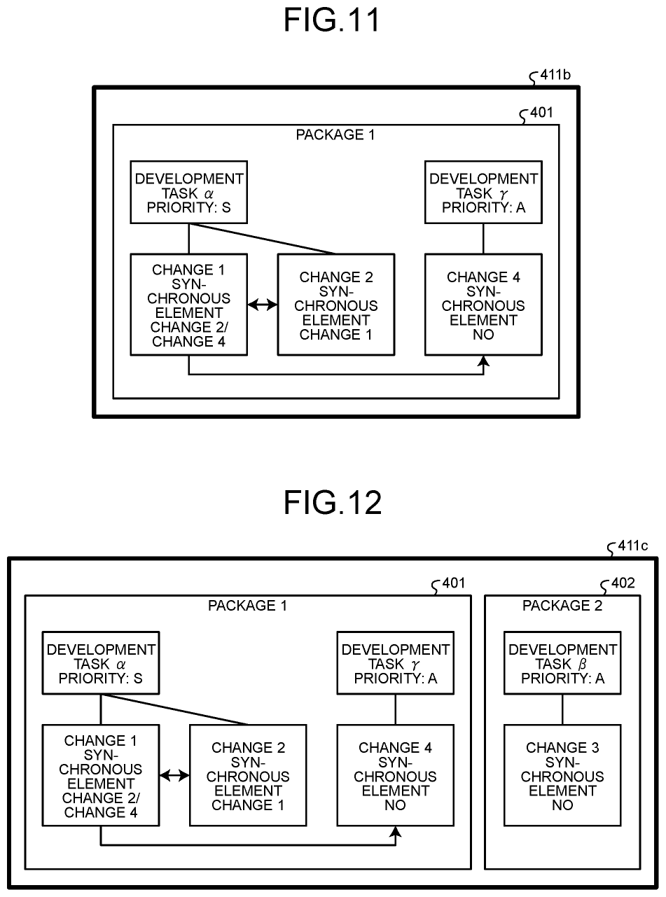

In an example, the build pattern defining module 72 generates the partial build patterns 411b and 411c sequentially in descending order of submission priority. FIGS. 11 and 12 are each a diagram illustrating generation of the partial build pattern in the multi-pattern build evaluation method according to an embodiment. For example, the present embodiment exemplifies four levels of the priorities S/A/B/C set in descending order. In this case, the build pattern defining module 72 generates the build patterns in the following order of the priorities: only priority S (the partial build pattern 411b in FIG. 11)→priority A (the partial build pattern 411c in FIG. 12)→ . . . →priorities S+B (excluding A)→priorities S+C→only priority A→priorities A+B→ . . . .

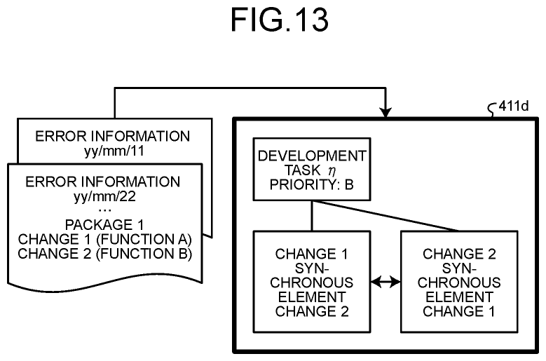

Note that, when a package includes a combination of pieces of change information that have caused troubles, that is, errors, in the past builds, the build pattern defining module 72 may generate a past troubled build pattern and execute a build with the highest priority. FIG. 13 is a diagram illustrating generation of the partial build pattern in the multi-pattern build evaluation method according to the embodiment. FIG. 13 illustrates the past troubled build pattern based on the error information, as the partial build pattern 411d. As described above, information about the synchronous element may be left in the error information upon the build so that the build priority is increased for a combination that has caused an error a plurality of times in the past to find a bug early.

Note that in a case where a combination having a high error frequency is preferentially included in the build pattern by linking the synchronous element and the error information in the past, the change information having a low priority may be excluded from the package including a combination having caused a trouble in the past.

In addition, the build module 73 allocates the partial build patterns to the resources sequentially so that the build is executed from the partial build pattern having a higher submission priority (S110), and causes the resources to execute the builds for the allocated partial build patterns (S111). At that time, the build module 73 predicts a build time in advance and allocates the partial build patterns to the resources so that the completion time does not exceed the deadline. When prepared resources are fully occupied, the build module 73 finishes the allocation even if the execution of a build for the build pattern having a lower submission priority has not finished. Then, the build module 73 monitors build situations and updates the build completion time. When the updated completion time exceeds the deadline specified in the development ticket and the builds cannot be achieved within the deadline, the build module 73 increases the resources to be allocated to the builds having higher priorities and reduces the resources for or temporarily stops the execution of the builds having lower priorities.

Note that allocation of the resources by the build module 73 includes a step of checking an available build machine 8. Furthermore, the allocation includes a step of acquiring a source code modification amount included in each partial build pattern by referring to the change information. In addition, the allocation includes a step of referring to a past build history and acquiring the build time from the processing capability of each build machine 8 and the source code modification amount that are closer to each other. Furthermore, the allocation includes a step of referring to the development tickets and checking the remaining time to complete the build, on the basis of both a development ticket having the earliest deadline date and the current time. In addition, the allocation includes a step of allocating the partial build patterns to the resources sequentially in descending order of priority so as to perform build submission within the remaining time specified in the development ticket. At this time, the build module 73 allocates the plurality of partial build patterns to the plurality of build machines 8 in parallel so as to be complete the build submission within the deadline. Furthermore, when the processing capacity of a certain build machine 8 is filled, the allocation destination is changed by the build module 73 to a next build machine 8.

Then, the build module 73 checks the build result of the overall build pattern (S112), and when the build result indicates NG (S113: No), the build module 73 acquires the results of the partial build patterns sequentially in descending order of submission priority (S114).

On the other hand, when the build result of the overall build pattern or the build result of a partial build pattern indicates OK (S113: Yes), the build module 73 combines the source code of the change information included in the build pattern with the main source tree (S115).

As described above, the multi-pattern build evaluation method according to an embodiment generates a plurality of build patterns obtained by bundling a small number of changes on the basis of the synchronous element, and performs evaluation by combining the build patterns in descending order of priority. Specifically, in the multi-pattern build evaluation method according to an embodiment, changes individually applied to the source code are collected, a combination causing an error is identified, and a combination causing no error is combined with the source tree. The multi-pattern build evaluation method according to an embodiment performs the build with a partial build pattern obtained by bundling a small number of changes, before being combined to the source tree, and identifies a combination causing the build error. At this time, the multi-pattern build evaluation method according to an embodiment is configured to reduce the number of combinations to be tested by grouping changes to be simultaneously combined with the source tree on the basis of the synchronous element. In addition, in the multi-pattern build evaluation method according to an embodiment, priorities are allocated to the combinations, and the resource allocation amount and process start timing are operated so that the build of the partial build pattern including the change information having a higher priority is completed within a desired deadline.

According to this configuration, it is possible to find an error early that is caused when the changes of the source codes individually made in each category are combined. In other words, it is possible to find failure early that is caused when changes of the source codes individually made in each category are combined, in combining the source codes in large-scale development.

In the present embodiment, occurrence of the build error (build result indicating NG) has been described as an example of the error, but the present disclosure is not limited thereto. The multi-pattern build evaluation method according to the present embodiment is not limited to the build error, and may consider detection of an operation failure or defect in operation check (test) after the build, as the error. Similarly, for the generation of the build pattern and the resource allocation based on the error information in the past, not only the build error in the past, but also error information about an error caused upon detection of an operation failure or defect in operation check (test) after the past build may be used.

Note that in the above embodiments, “determine whether something is A” may be “determine that something is A”, “determine that something is not A”, or “determine whether something is A or not”.

In any of the above embodiments, programs executed on the devices of the multi-pattern build evaluation system 1 are provided by being recorded in the form of installable or executable file, on a computer-readable recording medium, such as CD-ROM, FD, CD-R, and DVD

In addition, in any of the above embodiments, the programs executed on the devices of the multi-pattern build evaluation system 1 may be configured to be stored on a computer connected to a network such as the Internet and provided by being downloaded via the network. In addition, the programs executed on the devices of the multi-pattern build evaluation system 1 may be provided or distributed via a network such as the Internet.

In addition, in any of the above embodiments, the programs executed on the devices of the multi-pattern build evaluation system 1 may be provided by being incorporated in ROM and the like in advance.

In addition, in any of the above embodiments, a program executed on the source code management server 5 has a module configuration including the above-described functional unit (the synchronous element registration module 51), and as actual hardware, the processor 91 reads the program from the auxiliary storage device 93 and executes the program to load the functional unit on the main storage device 92, and the functional unit is generated on the main storage device 92.

In addition, in any of the above embodiments, a program executed on the build job management server 7 has a module configuration including the above-described functional units (the packing module 71 (the link module 711 and the processing module 712), the build pattern defining module 72, and the build module 73), and as actual hardware, the processor 91 reads the program from the auxiliary storage device 93 and executes the program to load each of the functional units on the main storage device 92, and each of the functional units is generated on the main storage device 92.

According to at least one embodiment described above, it is possible to find failure early that is caused when changes of the source codes individually made in each category are combined, in combining the source codes in large-scale development.

According to the present disclosure, it is possible to find failure early that is caused when changes of source codes individually made in each category are combined, in combining the source codes in large-scale development.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

### (Supplementary Note)

The following technique is disclosed from the above descriptions of the embodiments.

(1) A multi-pattern build evaluation method comprising:
acquiring, for each of a plurality of changed source codes, change information including information indicating a changed source code and synchronous element information indicating a synchronous element related between the changed source code and another changed source code;
generating two or more packages including one or more pieces of the change information based on the synchronous element information between the plurality of changed source codes; and
generating an overall build pattern including all of the two or more packages and partial build patterns including some of the two or more packages.

(2) In the multi-pattern build evaluation method according to (1), the information indicating the source code includes at least one of the source code, information indicating a content of change of the source code, and information indicating an access destination of either the source code or the information indicating the content of the change.

(3) In the multi-pattern build evaluation method according to (1) or (2), the change information includes synchronous element information defined by a user.

(4) The multi-pattern build evaluation method according to any one of (1) to (3), further includes defining the synchronous element based on a reference destination to the changed source code.

(5) In the multi-pattern build evaluation method according to any one of (1) to (4), the change information includes information indicating a development ticket giving an instruction on change of the source code, and
the method further includes defining the synchronous element based on the information indicating the development ticket.

(6) In the multi-pattern build evaluation method according to any one of (1) to (5), the change information includes information indicating a development ticket giving an instruction on change of the source code, and
the method further includes generating the partial build patterns based a build priority defined by the development ticket.

(7) In the multi-pattern build evaluation method according to any one of (1) to (6), the change information includes error information upon a past build, and
the method further includes generating the partial build patterns including two or more of the packages having caused an error in the past build.

(8) The multi-pattern build evaluation method according to any one of (1) to (7), further includes:
executing builds of a plurality of source codes defined by the overall build pattern and one or more source codes defined by the partial build patterns;
adopting a build result of the overall build pattern when the build of the overall build pattern is successfully executed; and
adopting a build result from one or more build patterns, for which the builds are successfully executed, of the partial build patterns, when the build of the overall build pattern results in failure.

(9) In the multi-pattern build evaluation method according to (8), the change information includes information indicating a development ticket giving an instruction on change of the source code, and
the method further includes allocating resources of build destinations to the partial build patterns in descending order, sequentially from a partial build pattern including the change information having a higher build priority defined by the development ticket, subsequent to the overall build pattern.

(10) In the multi-pattern build evaluation method according to (8) or (9), the change information includes error information upon a past build, and
the method further includes preferentially allocating a resource of a build destination to the partial build pattern having caused an error in a past build.

(11) A computer program product including programmed instructions embodied in and stored on a non-transitory computer readable medium, wherein the instructions, when executed by a computer, cause the computer to perform:
acquiring, for each of a plurality of changed source codes, change information including information indicating a changed source code and synchronous element information indicating a synchronous element related between the changed source code and another changed source code;
generating two or more packages including one or more pieces of the change information based on the synchronous element information between the plurality of changed source codes; and
generating an overall build pattern including all of the two or more packages and partial build patterns including some of the two or more packages.

(12) A program for causing a computer to execute the multi-pattern build evaluation method according to any one of (2) to (10) described above.

(13) A recording medium (computer program product) recording a program according to (11) or (12) described above, the program being executed by a computer.

What is claimed is:

1. A multi-pattern build evaluation method comprising:
acquiring, for each of a plurality of changed source codes, change information including information indicating a changed source code and synchronous element information indicating a synchronous element related between the changed source code and another changed source code;
generating two or more packages including one or more pieces of the change information based on the synchronous element information between the plurality of changed source codes; and
generating an overall build pattern including all of the two or more packages and partial build patterns including some of the two or more packages.

2. The multi-pattern build evaluation method according to claim 1, wherein
the information indicating the source code includes at least one of the source code, information indicating a content of change of the source code, and information indicating an access destination of either the source code or the information indicating the content of the change.

3. The multi-pattern build evaluation method according to claim 1, wherein
the change information includes synchronous element information defined by a user.

4. The multi-pattern build evaluation method according to claim 1, further comprising
defining the synchronous element based on a reference destination to the changed source code.

5. The multi-pattern build evaluation method according to claim 1, wherein
the change information includes information indicating a development ticket giving an instruction on change of the source code, and
the method further comprises defining the synchronous element based on the information indicating the development ticket.

6. The multi-pattern build evaluation method according to claim 1, wherein
the change information includes information indicating a development ticket giving an instruction on change of the source code, and
the method further comprises generating the partial build patterns based a build priority defined by the development ticket.

7. The multi-pattern build evaluation method according to claim 1, wherein
the change information includes error information upon a past build, and
the method further comprises generating the partial build patterns including two or more of the packages having caused an error in the past build.

8. The multi-pattern build evaluation method according to claim 1, further comprising:
executing builds of a plurality of source codes defined by the overall build pattern and one or more source codes defined by the partial build patterns;
adopting a build result of the overall build pattern when the build of the overall build pattern is successfully executed; and
adopting a build result from one or more build patterns, for which the builds are successfully executed, of the partial build patterns, when the build of the overall build pattern results in failure.

9. The multi-pattern build evaluation method according to claim 2, further comprising:
executing builds of a plurality of source codes defined by the overall build pattern and one or more source codes defined by the partial build patterns;
adopting a build result of the overall build pattern when the build of the overall build pattern is successfully executed; and
adopting a build result from one or more build patterns, for which the builds are successfully executed, of the partial build patterns, when the build of the overall build pattern results in failure.

10. The multi-pattern build evaluation method according to claim 3, further comprising:
executing builds of a plurality of source codes defined by the overall build pattern and one or more source codes defined by the partial build patterns;
adopting a build result of the overall build pattern when the build of the overall build pattern is successfully executed; and
adopting a build result from one or more build patterns, for which the builds are successfully executed, of the partial build patterns, when the build of the overall build pattern results in failure.

11. The multi-pattern build evaluation method according to claim 4, further comprising:
executing builds of a plurality of source codes defined by the overall build pattern and one or more source codes defined by the partial build patterns;
adopting a build result of the overall build pattern when the build of the overall build pattern is successfully executed; and
adopting a build result from one or more build patterns, for which the builds are successfully executed, of the partial build patterns, when the build of the overall build pattern results in failure.

12. The multi-pattern build evaluation method according to claim 5, further comprising:
executing builds of a plurality of source codes defined by the overall build pattern and one or more source codes defined by the partial build patterns;
adopting a build result of the overall build pattern when the build of the overall build pattern is successfully executed; and
adopting a build result from one or more build patterns, for which the builds are successfully executed, of the partial build patterns, when the build of the overall build pattern results in failure.

13. The multi-pattern build evaluation method according to claim 6, further comprising:
executing builds of a plurality of source codes defined by the overall build pattern and one or more source codes defined by the partial build patterns;
adopting a build result of the overall build pattern when the build of the overall build pattern is successfully executed; and
adopting a build result from one or more build patterns, for which the builds are successfully executed, of the partial build patterns, when the build of the overall build pattern results in failure.

14. The multi-pattern build evaluation method according to claim 7, further comprising:
executing builds of a plurality of source codes defined by the overall build pattern and one or more source codes defined by the partial build patterns;
adopting a build result of the overall build pattern when the build of the overall build pattern is successfully executed; and
adopting a build result from one or more build patterns, for which the builds are successfully executed, of the partial build patterns, when the build of the overall build pattern results in failure.

15. The multi-pattern build evaluation method according to claim 8, wherein
the change information includes information indicating a development ticket giving an instruction on change of the source code, and
the method further comprises allocating resources of build destinations to the partial build patterns in descending order, sequentially from a partial build pattern including the change information having a higher build priority defined by the development ticket, subsequent to the overall build pattern.

16. The multi-pattern build evaluation method according to claim 8, wherein
the change information includes error information upon a past build, and
the method further comprises preferentially allocating a resource of a build destination to the partial build pattern having caused an error in a past build.

17. A computer program product including programmed instructions embodied in and stored on a non-transitory computer readable medium, wherein the instructions, when executed by a computer, cause the computer to perform:
acquiring, for each of a plurality of changed source codes, change information including information indicating a changed source code and synchronous element information indicating a synchronous element related between the changed source code and another changed source code;
generating two or more packages including one or more pieces of the change information based on the synchronous element information between the plurality of changed source codes; and
generating an overall build pattern including all of the two or more packages and partial build patterns including some of the two or more packages.
